(19) United States
(12) Patent Application Publication
(10) Pub. No.: US 2025/0257542 A1
(43) Pub. Date: Aug. 14, 2025

(54) FOUNDATION MEMBERS FOR REACTIVE SOILS AND METHODS AND MACHINES FOR INSTALLING SAME

(71) Applicant: Ojjo, Inc., San Rafael, CA (US)

(72) Inventors: Steven Kraft, Albany, CA (US); Charles Almy, Berkeley, CA (US); Ian Capsuto, Berkeley, CA (US)

(21) Appl. No.: 19/050,693

(22) Filed: Feb. 11, 2025

Related U.S. Application Data
(60) Provisional application No. 63/552,589, filed on Feb. 12, 2024.

(51) Int. Cl. E02D 7/26; E02D 5/80

(52) U.S. Cl. CPC E02D 7/26; E02D 5/801; E02D 2600/30

(57) ABSTRACT

A method of embedding a threaded foundation component in ground with a layer of reactive soil with a combined drilling and driving machine includes: with an automated controller executing a control program, controlling the machine to begin an automated embedment operation to drive a threaded foundation component into a reactive soil; with the automated controller, controlling the machine to decouple a feed rate of the component from a rotary speed rate of the component to cause sheering of the soil around the foundation component by threads of the foundation component; and with the automated controller, controlling the machine to recouple the feed rate of the component to rotary speed rate of the component to reduce sheering of the soil around the foundation component by the threads of the foundation component until a target embedment depth for the foundation component is reached.

### RELATED APPLICATION

This application claims priority to U.S. Provisional Patent Application No. 63/552,589 filed on Feb. 12, 2024, the contents of which are hereby incorporated by reference.

### BACKGROUND

The applicant of this invention, OJJO, INC of San Rafael, CA, has developed a unique and commercially successful foundation for supporting single-axis solar trackers and other structures known commercially as EARTH TRUSS. The EARTH TRUSS, as currently manufactured and sold is a five-piece foundation assembled in a fast, efficient, repeatable, and highly accurate process. The process starts with driving a pair of adjacent components into the ground along desired vectors to straddle an intended North-South oriented tracker row so that each component points a common point in free space known as the work point of the truss relative to the rotational axis of the tracker that is being supported. This is done with applicant's proprietary TRUSS DRIVER machine drives screw anchors into the ground while providing in-situ drill assist, enabling the components to be embedded into any soil, including solid rock, without a separate predrill step. Then, after both anchors of the pair are driven, the mast of the machine self-orients to an assembly orientation above the driven screw anchors where the apex component known as a truss cap is loaded onto and held in place by a jig or holder on the machine. Upper legs sections are then sleeved over connecting portions of the truss cap and down onto the head of each driven screw anchors. Once fitted into place, the ends of the upper legs overlapping the truss cap screw anchors are crimped using one or more retracting hydraulic crimpers attached to the machine thereby preserving the orientation of the completed EARTH TRUSS foundation. Exemplary EARTH TRUSS components as well as an assembled EARTH TRUSS foundation are shown in FIGS. 1 and 2. In FIG. 2, a conventional tracker bearing assembly is shown.

The EARTH TRUSS foundation has proven to be very robust in a variety of different soil types ranging from gravel soils to solid rock and everything in between. The computer-controlled TRUSS DRIVER machine adapts in real time while screw anchors are driven into the ground to provide drill assistance as needed based on conditions encountered during each embedment operation. This ensures that embedment is successfully achieved as quickly as possible while maintaining the requisite pull-out strength required to support a single-axis tracker at each foundation point. Despite the robustness of the EARTH TRUSS foundation, reactive soils such as clay subject to seasonal moisture cycles, as well as those in areas that experience frost heave, present unique challenges for all foundation types when supporting single-axis trackers. Clay-based soils have the potential to change volume and shift with changes in the amount of moisture in the soil but in regions that experience heavy seasonal rains followed by prolonged periods of drought, such as parts of the Southwestern United States, this effect is greater. Clays containing bentonite or vermiculate may increase in volume substantially (e.g., >10%) as they absorb moisture. This cyclical swelling and shrinking of the soil will tend to jack up embedded foundation components over time, degrading the integrity of the foundation and potentially damaging attached tracker components. Foundations with angled legs are particularly vulnerable due to the enlarged cross section in the upward direction. To deal with this problem the applicant of this disclosure has developed techniques and foundation components that are particularly well suited to withstanding reactive soils.

### SUMMARY

One embodiment includes a method of embedding a threaded foundation component in ground with a layer of reactive soil with a combined drilling and driving machine. This method embodiments includes the steps of: with an automated controller executing a control program, controlling the machine to begin an automated embedment operation to drive a threaded foundation component into a reactive soil with a combination of torque and downforce; for a first portion of the embedment operation, with the automated controller, controlling the machine to decouple a feed rate of the component from a rotary speed rate of the component to cause sheering of the soil around the foundation component by threads of the foundation component; and for a second portion of the embedment operation, with the automated controller, controlling the machine to recouple the feed rate of the component to rotary speed rate of the component to reduce sheering of the soil around the foundation component by the threads of the foundation component until a target embedment depth for the foundation component is reached.

In a further embodiment of this method, controlling the machine to begin an automated embedment operation comprises, with the automated controller, controlling a rotary driver to begin rotating the foundation component while simultaneously controlling a motor to pull down on the rotary driver. In some such examples, controlling the machine to decouple a feed rate of the component from a rotary speed rate of the component comprises, with the automated controller, controlling the rotary driver to rotate the foundation component at a speed resulting in a first linear embedment rate while controlling the motor to pull down on the rotary driver at a speed resulting in a second linear embedment rate that is different than the first linear embedment rate. In some such examples, the first linear embedment rate exceeds the second linear embedment rate. In some such examples, controlling the machine to recouple the feed rate of the component to rotary speed rate of the component comprises, with the automated controller, controlling the rotary driver to rotate the foundation component at a speed resulting in a first linear embedment rate while controlling the motor to pull down on the rotary driver at a speed resulting in substantially the same linear embedment rate as the first linear embedment rate.

In a further embodiment of this method, the method can additionally include: with the automated controller, controlling a drilling tool on the machine to actuate a drilling tool through the foundation component during the second portion of the embedment operation to assist with embedment of the foundation component based on one or more conditions detected by the controller during the embedment operation. In some such examples, the conditions are selected from the group consisting of hydraulic pressure, embedment rate, and embedment depth.

Another embodiment includes a method of embedding a threaded foundation component in ground with a layer of reactive soil with a combined drilling and driving machine. This method embodiment includes: with an automated controller executing a control program, controlling the machine to begin an automated embedment operation to drive a threaded foundation component into a reactive soil with a combination of torque and downforce; for a first portion of the embedment operation, with the automated controller, controlling the machine to advance a drill bit through the foundation component to extend out of an open lower end to cause sheering of the soil around the foundation component; and for a second portion of the embedment operation, with the automated controller, controlling the machine to retract the expanding drill bit back into the foundation component and to continue to embed the foundation component until a target embedment depth is reached.

In a further embodiment of this method, controlling the machine to begin an automated embedment operation comprises, with the automated controller, controlling a rotary driver to begin rotating the foundation component while simultaneously controlling a motor to pull down on the rotary driver.

In a further embodiment of this method, the method additionally includes: with the automated controller, controlling the machine to advance the expanding drill bit through the foundation component to extend out of the open lower end during the second portion of the embedment operation to assist with embedment of the foundation component based on one or more conditions detected by the controller during the embedment operation. In some such examples, the conditions are selected from the group consisting of hydraulic pressure, embedment rate, and embedment depth

Another embodiment includes a foundation component for use in ground with a layer of reactive soil comprising: an elongated hollow shaft; a driving coupler at a first end of the hollow shaft; an external thread form beginning proximate to a second end of the hollow shaft and extending along its length; and at least one shearing feature formed on an outer surface of the shaft between the thread form and the driving coupler.

### BRIEF DESCRIPTION OF DRAWING FIGURES

FIG. 1 is a plan view of an embodiment of components for a foundation for supporting single-axis solar trackers.

FIG. 2 is an assembled, elevational view of the components of FIG. 1, along with a bearing assembly, to form an embodiment of the foundation for supporting single-axis solar trackers.

FIG. 3 is a cross sectional view of an example soil substrate that includes an active zone above a layer of hard soil.

FIG. 4 is an elevational view of an embodiment of an embedded screw anchor that has been driven through the active zone into the hard soil layer where soil around the component in the active zone has been pre-sheared using one or more of the various techniques discussed herein.

FIG. 5 is an elevational view of an embodiment of a portion of an exemplary mast of a screw anchor embedment and truss assembly machine.

FIG. 6 is a flow diagram of an embodiment of an automated method for driving a screw anchor through active soil to pre-shear the active zone of soil while embedding the anchor in the hard soil layer without pre-shearing that layer.

FIG. 7 is a flow diagram of an embodiment of a method (e.g., automated method) of using an expanding drill bit, within the screw anchor, extended out of the open lower end while driving the anchor through the active zone.

FIG. 8 is a flow diagram of an embodiment of method for ordinary driving where drill assist is provided on an as needed basis.

FIG. 9 is a box diagram of an embodiment of a control system for an installation and assembly machine and usable with the embodiments disclosed herein to execute the embodiments disclosed herein.

FIG. 10 is a side elevational view of an embodiment of screw anchor with pre-shearing features.

FIG. 11 is a side elevational view of an embodiment of a screw anchor with a consumable tip having a shearing feature projecting radially outward from the tip.

FIGS. 12A and 12B are elevational views of an embodiment of a portion of an exemplary mast of a screw anchor embedment and truss assembly machine with, respectively, a retracted wing and deployed wing drill bit.

### DETAILED DESCRIPTION

The following description is intended to convey a thorough understanding of the embodiments described by providing a number of specific embodiments and details involving truss foundations for terrain following single-axis solar trackers. It should be appreciated, however, that the present invention is not limited to these specific embodiments and details, which are exemplary only. It is further understood that one possessing ordinary skill in the art in light of known systems and methods, would appreciate the use of the invention for its intended purposes and benefits in any number of alternative embodiments, depending upon specific design and other needs.

As discussed in the background section, although the EARTH TRUSS foundation has enjoyed great success in many soil types, active soils present unique challenges. Foundations with angled legs may be more prone to damage from active soil than plumb driven foundations due to their larger cross section in the direction of upward expansion.

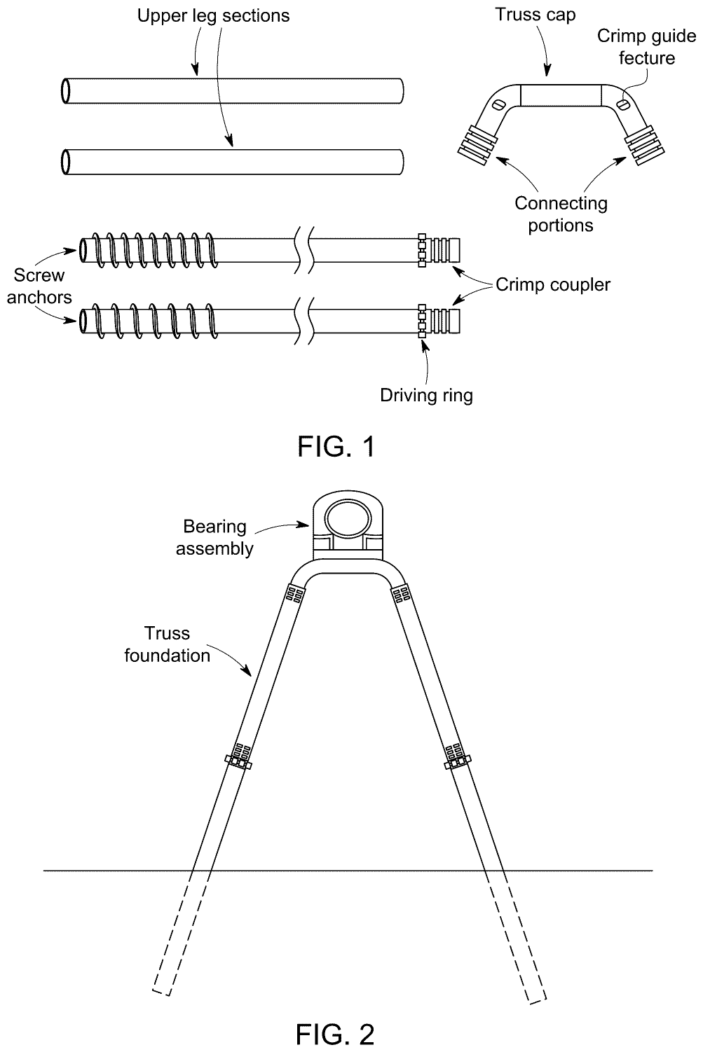

An example of applicant's EARTH TRUSS FOUNDATION for supporting single-axis solar trackers is shown in FIGS. 1 and 2. As shown in the figures, the EARTH TRUSS foundation consists of a pair of screw anchors that are driven partially into the ground, a pair of upper leg sections axially extending the screw anchors, and a so-called truss cap or truss adapter. The truss adapter unifies the foundation and also, in some cases provides a platform on which to attach the tracker bearing such as the bearing assembly shown in FIG. 2. In other cases, a bearing may be integrated into the truss cap. It should be appreciated that although the bearing assembly shown in FIG. 2 is a conventional tracker bearing where the torque tube rotates about its own axis, the EARTH TRUSS foundation may also support mechanically balanced trackers where the torque tube is suspended from a bearing pin and swings through an arc rather rotating.

Installation and assembly of the EARTH TRUSS is accomplished by embedding a pair of screw anchors on either side of a tracker row to point at a common point in free space, the truss work point. This is accomplished with applicant's proprietary TRUSS DRIVER machine which includes a rotary driver and drilling tool superimposed on the same mast. As the rotary driver embeds the screw anchor with a combination of rotation and downforce, the drilling tool extends through the rotary driver and down into the hollow screw anchor and is available as needed to provide real-time drill assist to the embedment operation. Once the pair of screw anchors have been driven to the desired embedment depth, the drill and rotary driver retract, and mast moves to an alignment orientation above the pair of embedded anchors. A truss cap is placed on a jig on the mast of the machine and held in place at the correct orientation. Then, upper leg sections are sleeved over the connecting portions of the truss cap and down onto the crimp coupler on the head of each embedded anchor. A hydraulic crimping tool attached to the machine is used to crimping the upper leg sections at the points where they overlap with the truss cap and each screw anchor to lock the geometry of the truss together. The machine is then moved down the tracker row to the next foundation location where the process is repeated.

When embedding screw anchors for EARTH TRUSS foundations the automated TRUSS DRIVER machine monitors the feed and speed of embedment adjusting both as necessary to insure that the threads of the anchor engage with the soil without pushing the anchor in too quickly (i.e., too much downforce which will tend to destroy the soil surrounding the threads) or without spinning the anchor too quickly (i.e., too much rotation which will tend to auger the soil). The screw anchor relies on both skin friction in the soil as well as the bearing capacity of the thread as it is “screwed” into the soil or rock to achieve its holding capacity. Accordingly, in most cases, it is important to manage the driving feed and speed rates during an embedment operation to ensure that the anchor achieves the maximum pull out resistance by engaging with the surrounding soil without overly impacting it. Because the rate of embedment will change over time based on soil density and presence of rocks and other obstructions encountered, these metrics must be changed dynamically for the embedment operation to remain optimized. However, as discussed in greater detail herein, there may be some cases where it will be desirable to decouple feed and speed to intentionally disturb the soil around the threads of the screw anchor as it is embedded, in particular, in soils with an active top layer

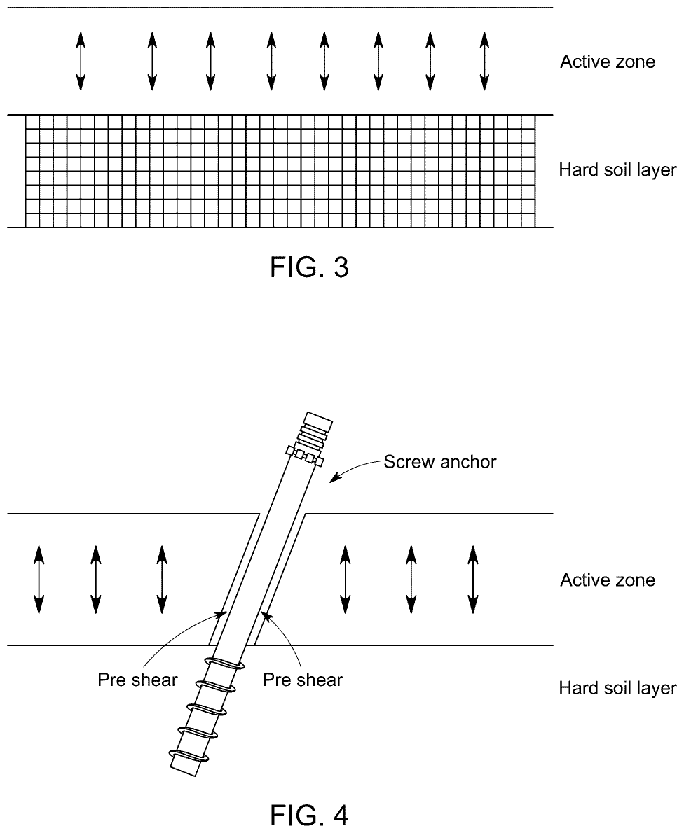

Turning to FIG. 3, this figure shows a cross sectional view of a soil substrate that includes an active zone above a layer of hard soil. This condition occurs commonly in drought prone areas of the American Southwest. The active zone may consist of two or more feet of expansive clay that adds little to the pullout resistance of the screw anchor while still exposing the foundation to risk of movement due to soil expansion when the soil becomes saturated with water. This type of soil may expand significantly in size when it becomes saturated with water and contract by the same amount as it dries back out. To prevent this expansion and subsequent contraction from jacking the foundation, various embodiments of the invention seek to pre-shear the soil in the active layer at the time the screw anchor is embedded. Jacking occurs when the expansive soil moves a cohesive layer. Separating the soil around the foundation component from that layer significantly reduces the forces imparted by it to the foundation. To that end, FIG. 4 shows an embedded screw anchor that has been driven through the active zone into the hard soil layer where soil around the component in the active zone has been pre-sheared using one or more of the various techniques discussed herein to ideally prevent or at least substantially reduce any jacking force that can be imparted by the expanding soil. Because the active zone adds little pull out resistance to the anchor, pre-shearing the soil has little impact on the pull-out strength as long as the anchor is embedded into the hard soil layer below where pre-shearing is not performed.

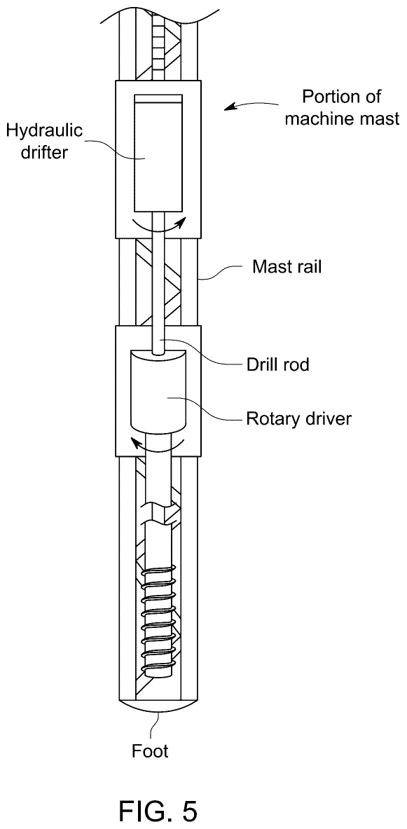

Turning now to FIG. 5, this figure shows a portion of an exemplary mast of a screw anchor embedment and truss assembly machine such as the TRUSS DRIVER. Though not shown in the figure, the mast is connected to the machine with a controllable linkage so that it may move in six degrees of freedom with respect to the machine (X direction, Y direction, Z direction, pitch, roll, and yaw). As shown, the mast has a pair of rails on either side. A hydraulic drifter or other drilling tool travels along the rails on an upper crowd. The rotary driver travels on the rails below the upper crowd on a lower crowd. A lower crowd motor at the base of the mast drives a drive chain connected to the upper and lower crowds to supply downforce to the drilling tool and the rotary driver. Though not shown in the figure, a separate upper crowd motor may enable the upper crowd and by extension the hydraulic drifter to travel independent of the lower crowd so that the drill bit can move independently of the rotary driver. As seen in FIG. 5, the drill rod extends down from the drifter passing through the rotary driver and down into the attached screw anchor foundation component. After a screw anchor is loaded onto the rotary driver, and the embedment operation initiated, the mast will adjust its pitch, roll, yaw, X position and Y position as necessary to enable the machine to embed the screw anchor along its desired driving axis.

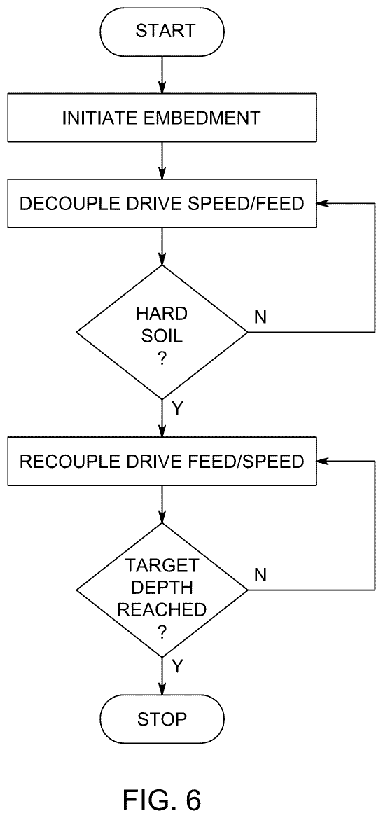

FIG. 6 details the steps of an automated method for driving a screw anchor through active soil to pre-shear the active zone of soil while embedding the anchor in the hard soil layer without pre-shearing that layer. The method begins at the step of initiating embedment. In various embodiments, this may be done by issuing a command on a wireless remote-control device used and/or worn by an operator of the machine. As discussed herein, this will cause the machine to adjust the orientation of the mast to align the mast's driving vector with the desired driving vector for the screw anchor. Once the mast is in position, the rotary driver begins rotating the screw anchor while the lower crowd motor pulls down on the lower crowd the rotary driver is attached to, providing a combination of torque and downforce to the screw anchor. Then, rather than following the default program routine of synchronizing the feed rate and rotational rate, these rates are intentionally decoupled so as to rotate the screw anchor at a fast rate of progression than the rate of downforce. This will auger the soil through the active layer causing the threads to lift the active layer of soil up and out of the embedment hole around the outer surface of the screw anchor. In various embodiments, the drilling tool may remain inside the screw anchor, near the open lower end, while this happens to prevent ingress of clay from the active layer. In various embodiments, the operator may input a depth or distance for the active layer before beginning the embedment operation (e.g., ½ meter). The controller of the machine may use this input to adjust the driving algorithm. In other embodiments, the machine may detect that the end of the active layer has been reached based on sensor data indicating a slow down in the embedment rate, increase in hydraulic pressure or other suitable proxy. This process of monitoring may be thought of logically as a decision box where the condition of hard soil is confirmed. If the hard surface layer has not been reached, in the exemplary method operation continues with speed and feed decoupled. Otherwise, if is determined that the hard soil layer has been reached, the embedment operation may revert back to standard operating mode where feed and speed are synchronized or coupled to minimize augering or coring by the anchor threads and the drill will be available for real-time drill assist as necessary. During the normal operation, the controller will monitor sensor data from encoders to determine if the target embedment depth has been reached. If not, operation continues. If so, the embedment operation terminates, and rotary driver and drilling tool are retracted back up the mast so that the next screw anchor may be loaded.

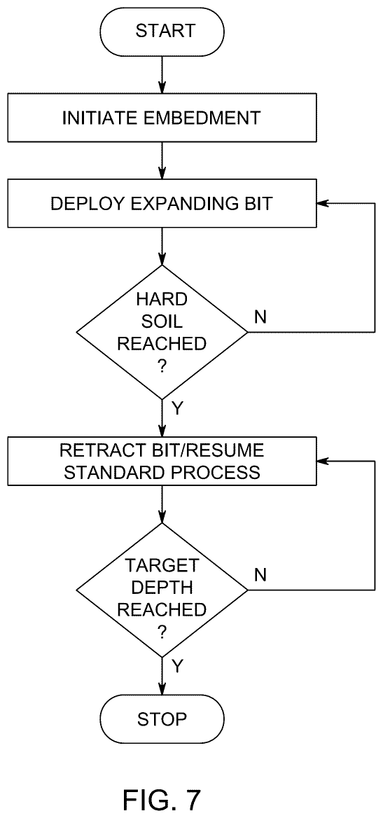

Although adjusting the feed and speed may be a preferred method of pre-shearing the soil, other methods are also available with the same equipment on the mast. For example, in some cases the expanding drill bit within the screw anchor, usually reserved for conditions where embedment slows or stalls, may be extended out of the open lower end while the driving the anchor through the active zone. This method is detailed in the flow chart shown in FIG. 7 and may be used in combination with the method described in FIG. 6. The method begins again after loading a screw anchor onto the chuck of the rotary driver by initiating the embedment operation. Once the machine mast has achieved its desired orientation, rotation and downforce are used to begin embedment. Unlike in the typical case where the drill bit may be held just inside the lower end of the anchor, in this case, the drill bit is extended out of the lower end by using the upper crowd motor to move the upper crowd down slightly relative to the position of the lower crowd. Because the bit is an expanding bit with wings that flare out when the bit escapes the anchor, it is able to cut a bore hold with a larger diameter than the inside diameter of the screw anchor where the bit is usually contained. Feed and speed of the rotary, and by extension of the screw anchor may be coupled as they are during normal embedment, or, alternatively, may be decoupled to enable the threads to auger drilling spoils up and around screw anchor as it travels down.

The embedment operation described in FIG. 7 continues with the expanding drill bit running ahead of or extending below the screw anchor as it cuts a path through the active zone. In various embodiments, the controller of the machine will monitor if the hard soil layer has been reached. As discussed herein, this may be done by simply monitoring the output of a linear or rotary encoder to determine if the predetermined distance has been reached. Alternatively, this may be done by monitoring the output of one or more other sensors to determine the real-time feed rate, hydraulic pressure, etc. which may serve as proxies for how much resistance the embedment operation and/or drilling tool is encountering at any given moment. Once it is determined that the hard soil layer has been reached, the automated controller may cause the drill bit to be retracted back into the open lower end of the screw anchor where it will remain available only as needed to help embed the screw anchor into the hard soil layer until the target embedment depth has been reached.

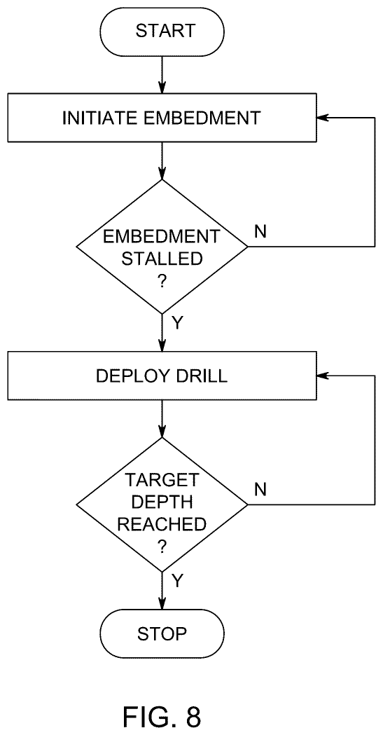

FIG. 8 is a flow chart detailing steps of a method of ordinary driving where drill assist is provided on an as needed basis. This may be used when driving in hard soil or may be used after passing through the active soil layer. The method begins by initiating embedment. In various embodiments this is the same as with other methods described in the context of FIGS. 6 and 7. Once embedment begins, the controller monitors sensor data indicative of the embedment operation in real time. This may include monitoring the rate of embedment, hydraulic pressure, depth of embedment, etc. At this time, the drill bit may be full retracted within the lower end of the screw anchor or may be partially extended just out of the open end, depending on the specific embedment recipe selected by the operator, but typically not so far extended that the wings deploy. If, based on the step of monitoring, no stall has been detected, embedment continues. Otherwise, if it is determined that a stall of embedment has occurred, the drilling tool may be deployed out of the lower open end to allow the expanding wings to deploy. In various embodiments, a stall is determined to have occurred when further application of torque and downforce fail to result in additional embedment. At the same time, the controller may control the rotary driver and lower crowd motor to slightly withdraw the screw anchor by counter rotating it while pulling up with the lower crowd motor to provide space for the expanding drill bit to deploy. Once the drill bit deploys the embedment operation may resume with the screw anchor following the drill bit into the ground. In various embodiments the controller will continue to monitor sensor data to determine if the target embedment depth has been reached. If so, the embedment operation stops, and the drilling tool and drill are withdrawn by upward force from the lower crowd motor and, if necessary, the upper crowd motor as well.

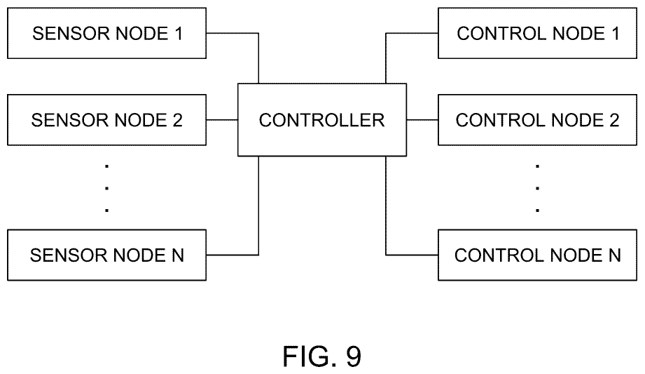

FIG. 9 is an exemplary control system for the TRUSS DRIVER installation and assembly machine usable with the various embodiments of the invention. The system is controlled by a controller such as a programmable logic controller (PLC), microprocess or other integrated circuit controller. The controller may be selected from any number of commercially available PLCs such as those manufactured and sold by Rockwell/Allen-Bradely, Bosch, Honeywell, or other suppliers. In various embodiments the controller may reside in a control box on the machine where it is connected to power and if applicable, to a communications link. On the left side of the control system shown in the figure are a plurality of sensor nodes 1-N, where N is an integer. These may consist of one or more sensors including but not limited to linear encoders, rotary encoders, inclinometers, accelerometers, temperature sensors, pressure sensors, or other suitable sensors. On the right side are a plurality of control nodes 1-N where N is another integer. The control nodes represent various mast and machine components that are controllable including the mechanical linkage between the mast and machine that controls its orientation, the upper crowd motor, the hydraulic drifter, the rotary driver, the lower crowd motor, the air compressor, the main hydraulic pump, etc. that are used during an embedment operation. It should be appreciated that some of these components may not be physically interconnected to one another but rather communicatively coupled through one or more wireless communication protocols. It also be appreciated that location within the drawing figure is exemplary only and does not imply any physical topology or physical proximity on the actual machine or mast.

In addition to using the controller to cause the screw anchor to pre-shear the soil, or as an alternative to doing so, in some cases it may be desirable to include features on the screw anchor itself that will pre-shear the soil as the screw is being embedded normally. Starting with FIG. 9, the screw anchor shown in the Figure includes a shearing feature along the shaft of the anchor consisting of a pair of fins. As the anchor is driven through the active soil layer, the rotation of the anchor will cause the fins to shear the surrounding soil to break it away from the surrounding soil.

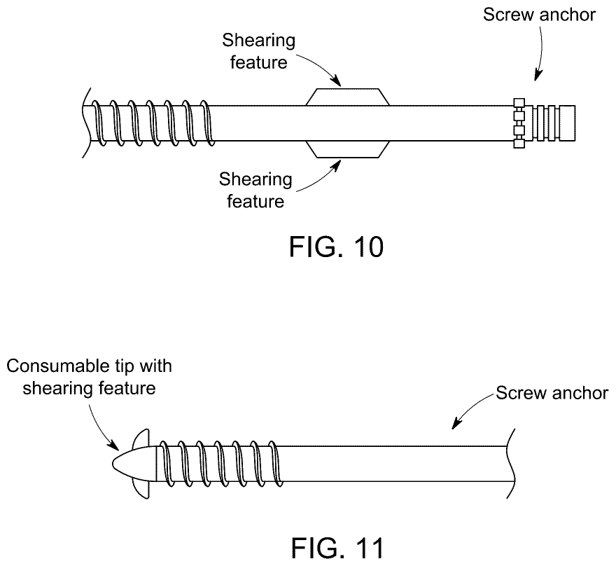

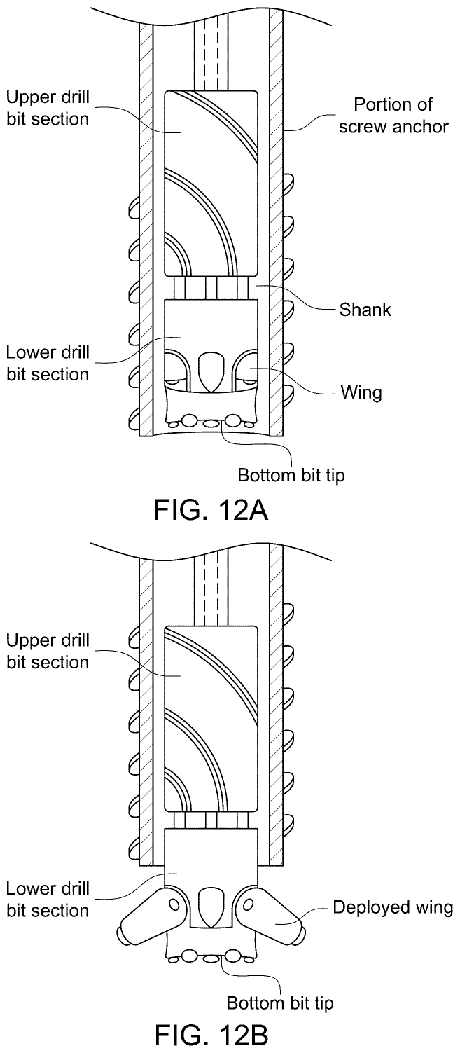

FIG. 10 shows another screw anchor with pre-shearing features. In the case of FIG. 10, a consumable tip is added to the lower end of the screw anchor. The tip may be made of concrete, wood, plastic, or other suitable material that will hold up through the relative soft reactive soil layer but will break away when the screw anchor encounters the hard soil layer. Such a material may be easily penetrated by the drilling tool to the extent it becomes necessary to provide drill assist in hard soil.

It should be appreciated that the embodiments described and claimed herein are exemplary only. Those of ordinary skill in the art will appreciate modifications and substitutions that retain the spirit and scope of the invention.

What is claimed is:

1. A method of embedding a threaded foundation component in ground with a layer of reactive soil with a combined drilling and driving machine, the method comprising:
with an automated controller executing a control program, controlling the machine to begin an automated embedment operation to drive a threaded foundation component into a reactive soil with a combination of torque and downforce;
for a first portion of the embedment operation, with the automated controller, controlling the machine to decouple a feed rate of the component from a rotary speed rate of the component to cause sheering of the soil around the foundation component by threads of the foundation component; and
for a second portion of the embedment operation, with the automated controller, controlling the machine to recouple the feed rate of the component to rotary speed rate of the component to reduce sheering of the soil around the foundation component by the threads of the foundation component until a target embedment depth for the foundation component is reached.

2. The method according to claim 1, wherein controlling the machine to begin an automated embedment operation comprises, with the automated controller, controlling a rotary driver to begin rotating the foundation component while simultaneously controlling a motor to pull down on the rotary driver.

3. The method according to claim 2, wherein controlling the machine to decouple a feed rate of the component from a rotary speed rate of the component comprises, with the automated controller, controlling the rotary driver to rotate the foundation component at a speed resulting in a first linear embedment rate while controlling the motor to pull down on the rotary driver at a speed resulting in a second linear embedment rate that is different than the first linear embedment rate.

4. The method according to claim 2, wherein the first linear embedment rate exceeds the second linear embedment rate.

5. The method according to claim 2, controlling the machine to recouple the feed rate of the component to rotary speed rate of the component comprises, with the automated controller, controlling the rotary driver to rotate the foundation component at a speed resulting in a first linear embedment rate while controlling the motor to pull down on the rotary driver at a speed resulting in substantially the same linear embedment rate as the first linear embedment rate.

6. The method according to claim 1, further comprising, with the automated controller, controlling a drilling tool on the machine to actuate a drilling tool through the foundation component during the second portion of the embedment operation to assist with embedment of the foundation component based on one or more conditions detected by the controller during the embedment operation.

7. The method according to claim 6, wherein the conditions are selected from the group consisting of hydraulic pressure, embedment rate, and embedment depth.

8. A method of embedding a threaded foundation component in ground with a layer of reactive soil with a combined drilling and driving machine, the method comprising:
with an automated controller executing a control program, controlling the machine to begin an automated embedment operation to drive a threaded foundation component into a reactive soil with a combination of torque and downforce;
for a first portion of the embedment operation, with the automated controller, controlling the machine to advance a drill bit through the foundation component to extend out of an open lower end to cause sheering of the soil around the foundation component; and
for a second portion of the embedment operation, with the automated controller, controlling the machine to retract the expanding drill bit back into the foundation component and to continue to embed the foundation component until a target embedment depth is reached.

9. The method according to claim 8 wherein controlling the machine to begin an automated embedment operation comprises, with the automated controller, controlling a rotary driver to begin rotating the foundation component while simultaneously controlling a motor to pull down on the rotary driver.

10. The method according to claim 8, further comprising, with the automated controller, controlling the machine to advance the expanding drill bit through the foundation component to extend out of the open lower end during the second portion of the embedment operation to assist with embedment of the foundation component based on one or more conditions detected by the controller during the embedment operation.

11. The method according to claim 10, wherein the conditions are selected from the group consisting of hydraulic pressure, embedment rate, and embedment depth.

12. A foundation component for use in ground with a layer of reactive soil comprising:
an elongated hollow shaft;
a driving coupler at a first end of the hollow shaft;
an external thread form beginning proximate to a second end of the hollow shaft and extending along its length; and
at least one shearing feature formed on an outer surface of the shaft between the thread form and the driving coupler.
